(19) United States
(12) Patent Application Publication
(10) Pub. No.: US 2024/0290947 A1
(43) Pub. Date: Aug. 29, 2024

(54) Solution Deposited Silicon in Porous Conductive Particles for Use in a Lithium Battery Anode

(71) Applicant: Honeycomb Battery Company, Dayton, OH (US)

(72) Inventor: Bor Z. Jang, Centerville, OH (US)

(73) Assignee: Honeycomb Battery Company, Dayton, OH (US)

(21) Appl. No.: 18/171,505

(22) Filed: Feb. 20, 2023

(51) Int. Cl. H01M 4/36; C01B 32/19; C01B 32/196; C01B 32/21; H01M 4/133; H01M 4/134; H01M 4/38; H01M 4/587; H01M 4/62; H01M 10/0525

(52) U.S. Cl. CPC H01M 4/364; C01B 32/19; C01B 32/196; C01B 32/21; H01M 4/133; H01M 4/134; H01M 4/366; H01M 4/386; H01M 4/387; H01M 4/587; H01M 4/62; H01M 10/0525; C01B 2204/22; H01M 2004/021; H01M 2004/027

(57) ABSTRACT

A process for producing a solid powder mass of multiple individual Si-containing porous particulates, comprising (a) providing a solid powder mass comprising multiple porous host particles having a volume fraction of pores from 5% to 99.9%, wherein the porous host particles are selected from carbonaceous, graphitic, graphene, or metallic particles; (b) introducing a reactive liquid or solution into pores of the porous particles wherein the reactive liquid or solution comprises silane-type species selected from cyclohexasilane, hexasilane, cyclopentasilane, neo-pentasilane, tectrasilane, trisilane, disilane, monosilane, a chemical derivative thereof, or a combination thereof; and (c) exposing the silane-type species to heat, ultra-violet light, laser beam, high-energy radiation (e.g., Gamma radiation, X-ray, electron beam), or a combination thereof to chemically convert the silane-type species into Si particles residing in the pores or Si coating deposited on pore walls to obtain the solid powder mass of separate multiple Si-containing porous particulates.

### FIELD

The present disclosure provides a method of producing Si-containing porous particulates with Si deposited in the pores of porous host particles (e.g., carbon, graphite, graphene, Cu, and Sn particles) for use in the anode (negative electrode) of a rechargeable lithium battery.

### BACKGROUND

Concerns over the safety of earlier lithium secondary batteries led to the development of lithium ion secondary batteries, in which pure lithium metal sheet or film was replaced by carbonaceous materials as the negative electrode (anode). The carbonaceous material may comprise primarily graphite that is intercalated with lithium and the resulting graphite intercalation compound may be expressed as LiₓC₆, where x is typically less than 1. In order to minimize the loss in energy density due to this replacement, x in LiₓC₆ should be maximized and the irreversible capacity loss Qir in the first charge of the battery should be minimized. The maximum amount of lithium that can be reversibly intercalated into the interstices between graphene planes of a perfect graphite crystal is generally believed to occur in a graphite intercalation compound represented by LiₓC₆ (x=1), corresponding to a theoretical specific capacity of 372 mAh/g.

In addition to carbon- or graphite-based anode materials, other inorganic materials that have been evaluated for potential anode applications include metal oxides, metal nitrides, metal sulfides, and a range of metals, metal alloys, and intermetallic compounds that can accommodate lithium atoms/ions. In particular, lithium alloys having a composition formula of LiₐA (A is a metal such as Al, and “a” satisfies 0<a<5) has been investigated as potential anode materials. This class of anode active materials has a higher theoretical capacity, e.g., Li₄Si (maximum capacity=3,829 mAh/g), Li_{4,4}Si (maximum capacity of Si=4,200 mAh/g), Li₄₄Ge (maximum capacity of Ge=1,623 mAh/g), Li₄₄Sn (maximum capacity of Sn=993 mAh/g), Li₃Cd (maximum capacity of Cd=715 mAh/g), Li₃Sb (maximum capacity of Sb=660 mAh/g), Li_{4,4}Pb (569 mAh/g), LiZn (410 mAh/g), and Li₃Bi (385 mAh/g).

An anode active material is normally used in a powder form, which is mixed with conductive additives and bonded by a binder resin. The binder also serves to bond the mixture to a current collector. Alternatively, an anode active material may be coated as a thin film onto a current collector. On repeated charge and discharge operations, the alloy particles tend to undergo pulverization and the current collector-supported thin films are prone to fragmentation due to expansion and contraction of the anode active material during the insertion and extraction of lithium ions. This pulverization or fragmentation results in loss of particle-to-particle contacts between the active material and the conductive additive or contacts between the anode material and its current collector. These adverse effects result in a significantly shortened charge-discharge cycle life.

To overcome the problems associated with such mechanical degradation, several approaches have been proposed, including (a) using nano-scaled particles of an anode active material, (b) composites composed of small electrochemically active particles supported by less active or non-active matrices or coatings, (c) metal alloying, and (d) using amorphous anode active material (instead of crystalline form). For instance, there has been work reported on synthesizing amorphous and nanostructured forms of silicon such as nanoparticles, nanowires and nanotubes. This was mostly based on the well-known electrochemical lithiation induced crystalline-to-amorphous silicon phase transformation during the first few cycles as well as conditions employed for synthesis of amorphous silicon.

It is generally believed that the nanostructured and amorphous forms of silicon provide mechanical integrity without pulverization due to the reduced number density of atoms within a nano-sized grain and the ‘free volume’ effects in amorphous silicon which results in better capacity retention and cycle life. Further, due to the presence of defects and absence of long range order in amorphous silicon, the volume expansion upon lithium insertion can be distributed homogenously and the net effect of crack formation and propagation can be less catastrophic compared to crystalline silicon. Hence, the amount of pulverization of the active material is significantly reduced which gives rise to enhanced capacity retention and cyclability.

Amorphous silicon is generally obtained by physical and chemical vapor deposition methods. Physical vapor deposition methods include RF or magnetron sputtering and pulsed laser deposition using silicon targets. Chemical vapor deposition methods include thermal, microwave or plasma assisted decomposition of silicon precursors such as silane, SiH₄. These techniques, though commonly implemented in the electronics industry, are not economically viable for secondary batteries. Secondary batteries used for consumer portable electronic devices and electric vehicles are subject to very stringent demands of competitive price reduction. Therefore, there is a need to explore alternative cost-effective approaches for generation of amorphous silicon. Although electro-deposition was attempted to produce anode electrodes (not the anode active material particles per se), these electrodes are too thin and do not have a high areal capacity, resulting in lower energy densities of the cells.

When the lithium-ion cell is assembled and filled with electrolyte, the anode and cathode active materials have a difference in potential of at most about 2 volts between the two. The difference in potential between the two electrodes, after the lithium-ion cell has been charged, is about 4 volts. When the lithium-ion cell is charged for the first time, lithium is extracted from the cathode and introduced into the anode. As a result, the anode potential is lowered significantly (toward the potential of metallic lithium), and the cathode potential is further increased (to become even more positive). These changes in potential may give rise to parasitic reactions on both electrodes, but more severely on the anode. For example, a decomposition product known as solid electrolyte interface (SEI) readily forms on the surfaces of anode carbon materials, wherein the SEI layer comprises lithium and electrolyte components. These surface layers or covering layers are lithium-ion conductors which establish an ionic connection between the anode and the electrolyte and prevent the reactions from proceeding any further.

Formation of this SEI layer is therefore necessary for the stability of the half-cell system comprising the anode and the electrolyte. However, as the SEI layer is formed, a portion of the lithium introduced into the cells via the cathode is irreversibly bound and thus removed from cyclic operation, i.e. from the capacity available to the user. This means that, during the course of the first discharge, not as much lithium moves from the anode back to the cathode as had previously been released to the anode during the first charging operation. This phenomenon is called irreversible capacity and is known to consume about 10% to 30% of the capacity of a lithium ion cell.

A further drawback is that the formation of the SEI layer on the anode after the first charging operation may be incomplete and will continue to progress during the subsequent charging and discharge cycles. Even though this process becomes less pronounced with an increasing number of repeated charging and discharge cycles, it still causes continuous abstraction, from the system, of lithium which is no longer available for cyclic operation and thus for the capacity of the cell. Additionally, as indicated earlier, the formation of a solid-electrolyte interface layer consumes about 10% to 30% of the amount of lithium originally stored at the cathode, which is already low in capacity (typically <200 mAh/g). Clearly, it would be a significant advantage if the cells do not require the cathode to supply all the required amount of lithium.

Therefore, in summary, a need exists for an anode active material that has a high specific capacity, a minimal irreversible capacity (or a low decay rate), and a long cycle life. In order to accomplish these goals, we have worked diligently and intensively on the development of new electrode materials, which are in a powder form and can be incorporated with an optional binder and optional conductive additive to form an anode (negative electrode) of high areal capacity. These research and development efforts lead to the present patent application.

### SUMMARY

The present disclosure provides an anode active material for the anode (negative electrode) of a lithium battery (e.g. lithium-ion battery, lithium-sulfur battery, lithium-air battery, etc.) and a process for producing such an anode active material, the anode, and the battery cell. This new material enables the battery to deliver a significantly improved specific capacity and much longer charge-discharge cycle life.

In certain embodiments, the present disclosure provides a process for producing a solid powder mass of multiple individual Si-containing porous particulates, the process comprising (a) providing a solid powder mass comprising multiple porous host particles having a volume fraction of pores from 5% to 99.9%, wherein the porous host particles are electrically conducting having an electrical conductivity of no less than 10⁻⁶ S/cm; (b) introducing a reactive liquid or solution, containing a Si precursor, into pores of the porous particles, and (c) exposing the reactive liquid or solution species to heat, ultra-violet light, laser beam, high-energy radiation (e.g., Gamma radiation, X-ray, and/or electron beam), or a combination thereof to convert the Si precursor into Si particles residing in the pores or into Si coating deposited on pore walls to obtain the solid powder mass of separate (non-bonded) multiple Si-containing porous particulates. These multiple Si-containing porous particulates are physically separate particles not bonded by any binder before they are made into an anode electrode at a later stage. In some embodiments, the porous host particles are selected from carbonaceous, graphitic, graphene, or metallic particles. In some preferred embodiments, the reactive liquid or solution comprises silane-type species, as a Si precursor, selected from Cyclohexasilane (CHS), Hexasilane (HS), Cyclopentasilane (CPS), neo-pentasilane (NPS), isotectrasilane, trisilane, a chemical derivative thereof, a combination thereof; or a combination thereof with disilane or monosilane.

In certain preferred embodiments, the disclosure provides a process for producing a solid powder mass of multiple individual Si-containing porous particulates, the process comprising (a) providing a solid powder mass comprising multiple porous host particles having a volume fraction of pores from 5% to 99.9%, wherein the porous host particles are selected from carbonaceous, graphitic, graphene, or metallic particles; (b) introducing a reactive liquid or solution into pores of the porous particles wherein the reactive liquid or solution comprises silane-type species (polysilane) selected from Cyclohexasilane (CHS), Hexasilane (HS), Cyclopentasilane (CPS), neo-pentasilane (NPS), tectrasilane (e.g., isotectrasilane), trisilane, a chemical derivative thereof, a combination thereof; or a combination thereof with disilane or monosilane, and (c) exposing the silane-type species to heat, ultra-violet light, laser beam, high-energy radiation (e.g., Gamma radiation, X-ray, and/or electron beam), or a combination thereof to convert the silane-type species into Si particles residing in the pores or Si coating deposited on pore walls to obtain the solid powder mass of separate (non-bonded) multiple Si-containing porous particulates.

In general, the deposited anode active material (e.g., Si coating or particles) does not fully occupy the pores, allowing a sufficient amount of voids to accommodate the volume expansion of Si during the battery charging procedure. Most preferably, the residual pore-to-Si volume ratio is from 0.5 to 5.0, further preferably from 1.0 to 3.0. The Si coating or Si particles preferably have a thickness or diameter from nm to 1 μm, more preferably from 10 nm to 500 nm and further preferably from 20 nm to 150 nm.

In certain embodiments, the porous graphene particles comprise graphene sheets selected from pristine graphene, graphene fluoride, graphene chloride, graphene bromide, graphene iodide, nitrogenated graphene, hydrogenated graphene, doped graphene, chemically functionalized graphene, graphene oxide, reduced graphene oxide, or a combination thereof.

The porous carbonaceous or graphitic particles preferably comprise particles of activated carbon, soft carbon (defined as a carbon material that is graphitizable), hard carbon (non-graphitizable even at a temperature higher than 2.500° C.), polymeric carbon (e.g., carbonized resin in a bulk, film, or fibrous form), activated natural graphite, activated artificial graphite, exfoliated graphite worms, expanded graphite flakes, meso-phase carbon, needle coke, or a combination thereof.

The host metallic particles preferably comprise a metal selected from a transition metal 5 (e.g., Cu, Mn, Co, Ni. Ti), Al, Ga, In, Sn, Bi, an alloy thereof, or a combination thereof. The porous metallic particles, as a host, can be selected from Cu, Al, steel, Sn, Zn, Ti, Mn, Co, Ni, or any other transition metal. The metal may be coated with a passivation layer (e.g., carbon or polymer).

These particulates are in a powder form that can be readily incorporated with an optional binder and optional conductive additive to form an anode (negative electrode) of high areal capacity, typically higher than 4.5 mAh/cm², more typically higher than 6 mAh/cm², further typically and desirably higher than 10 mAh/cm², still more typically and desirably higher than 20 mAh/cm², 30 mAh/cm², 50 mAh/cm², etc. These high areal capacities normally could not be achieved if one chose to deposit pure Si directly on a current collector.

The process may further comprise a procedure of encapsulating or coating the porous anode material particulates with a thin protecting layer having a thickness from 0.5 nm to 2 μm. The protecting lay preferably comprises carbon (e.g., amorphous carbon, polymeric carbon or carbonized polymer), graphene, electron-conducting polymer, lithium ion-conducting polymer, or a combination thereof.

In some embodiments, the process further includes a procedure of prelithiating the multiple anode material particulates, wherein the anode material particles are prelithiated to contain an amount of lithium from 1% to 100% of a maximum lithium content contained in the anode active material (i.e., Si).

The maximum lithium content in an active material may be defined as the theoretical capacity of this material. For instance, when Si is fully charged with lithium, the resulting material may be represented by a formula Li₄₄Si, which indicates a maximum charge storage capacity of 4,200 mAh/g and corresponds to a lithium weight fraction of 57.4% based on the weight of this fully lithiated Si material. In certain preferred embodiments, the particle of anode active material comprises a doped semiconductor Si material, which is doped with n-type and/or p-type dopants. In some preferred embodiments, the anode active material comprises silicon and the prelithiated Si particle is selected from LiₓSi, wherein numerical x is from 0.01 to 4.4.

The process may further comprise a procedure of encapsulating or coating the prelithiated anode material particulates with a thin protecting layer having a thickness from 0.5 nm to 2 μm. In some embodiments, the protecting layer comprises a carbon material, graphene, a polymer, or a lithium- or sodium-containing species chemically bonded to the particulates and the lithium- or sodium-containing species is selected from Li₂CO₃, Li₂C₂O₄, LiOH, LiCl, LiI, LiBr, ROCO₂Li, HCOLi, ROLi, (ROCO₂Li)₂, (CH₂OCO₂Li)₂, Li₂S, LiₓSO_{y}, Li₄B, Na₄B, Na₂CO₃, Na₂O, Na₂C₂O₄, NaOH, NaX, ROCO₂Na, HCONa, RONa, (ROCO₂Na)₂, (CH₂OCO₂Na)₂, Na₂S, NaₓSO_{y}, a combination thereof, a combination thereof with Li₂O or LiF, or a combination of Li₂O and LiF, wherein X=F. Cl, I, or Br. R=a hydrocarbon group, x=0−1, y=1−4.

In some embodiments, the protecting layer comprises a thin layer of a high-elasticity polymer having a fully recoverable tensile strain from 5% to 1,000%, and a lithium ion conductivity from 10⁻⁷ S/cm to 5×10⁻² S/cm at room temperature.

The process step of prelithiating may include a procedure selected from chemical prelithiation, electrochemical lithiation, solution lithiation, physical lithiation, or a combination thereof. In certain embodiments, the step of prelithiating includes conducting electrochemical prelithiation in the first electrodeposition chamber or in a second electrodeposition chamber different than the first chamber.

The process may further comprise a step of forming the multiple anode material particulates, along with an optional binder and optional conductive additive, into an anode electrode. The process may further comprise a step of combining the anode electrode with a cathode, and an electrolyte to form a battery cell.

The disclosure also provides a solid powder mass of multiple anode (Si) material particulates produced by the process discussed above. Further disclosed is an anode electrode that comprises multiple anode material particulates produced by the described process, an optional conductive additive, and an optional binder. Also disclosed is a lithium-ion or lithium metal battery containing the anode electrode described above, a cathode electrode, and an electrolyte in ionic contact with the anode electrode and the cathode electrode.

### BRIEF DESCRIPTION OF THE DRAWINGS

FIG. 1 Schematic of a process for producing porous conducting host particulates containing Si or prelithiated Si in the pores of the host particles, according to a preferred embodiment of the present disclosure.

FIG. 2 Schematic of an electrochemical process for prelithiating the deposited Si particles or coating in the pores of host particles, according to a preferred embodiment of the present disclosure.

FIG. 3 Electrochemical potential of the electrolyte relative to those of the anode and the cathode in a battery cell. The anode can act as a reductant and the cathode an oxidant of the electrolyte.

### DETAILED DESCRIPTION

This disclosure is related to anode materials for high-capacity lithium batteries, which are preferably secondary batteries based on a non-aqueous electrolyte, a polymer gel electrolyte, polymer electrolyte, quasi-solid electrolyte, inorganic solid-state electrolyte, or composite or hybrid electrolyte. The shape of a lithium metal or lithium ion battery can be cylindrical, square, button-like, etc. The present invention is not limited to any battery shape or configuration.

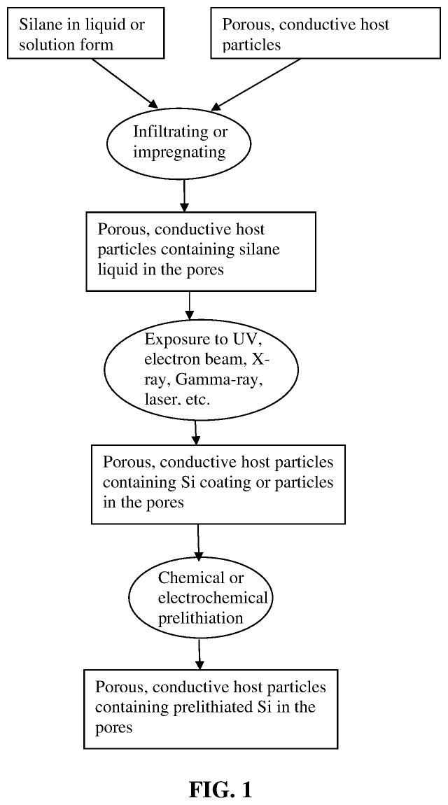

As illustrated in FIG. 1, the present disclosure provides a process for producing a solid powder mass of multiple individual Si-containing porous particulates, the process comprising (a) providing a solid powder mass comprising multiple porous host particles (e.g., carbonaceous, graphitic, graphene, or metallic particles) having a volume fraction of pores from 5% to 99.9%, wherein the porous host particles are electrically conducting having an electrical conductivity of no less than 10⁻⁶ S/cm; (b) introducing a reactive liquid or solution, containing a Si precursor, into pores of the porous particles, and (c) exposing the reactive liquid or solution species to heat, ultra-violet light, laser beam, high-energy radiation (e.g., Gamma radiation, X-ray, and/or electron beam), or a combination thereof to convert the Si precursor into Si particles residing in the pores or into Si coating deposited on pore walls to obtain the solid powder mass of separate (non-bonded) multiple Si-containing porous particulates. These multiple Si-containing porous particulates are physically separate particles not bonded by any binder before they are made into an anode electrode at a later stage. The Si coating or particles deposited in the pores may be subsequently prelithiated chemically or electrochemically.

These particulates are substantially separated from one another and are not bonded to one another with a binder. The pores inside the host particles are preferably interconnected to facilitate fast migration of Si atoms or ions during the solution deposition process. The volume fraction of pores is preferably from 30% to 95% and most preferably from 50% to 90%.

In some preferred embodiments, the reactive liquid or solution comprises silane-type species, as a Si precursor, selected from Cyclohexasilane (CHS), Hexasilane (HS), Cyclopentasilane (CPS), neo-pentasilane (NPS), isotectrasilane, trisilane, a chemical derivative thereof, a combination thereof; or a combination thereof with disilane or monosilane.

It may be noted that the simplest isomer of silane-type species is the one in which the silicon atoms are arranged in a single chain with no branches. This isomer is sometimes called the n-isomer (n for “normal”). However the chain of silicon atoms may also be branched at one or more points. The number of possible isomers increases rapidly with the number of silicon atoms. The members of the series (in terms of number of silicon atoms) and selected physical properties are shown in Table 1 below:

TABLE 1
Physical properties of small silanes:

| | | Boiling | Melting | Density |
|---|---|---|---|---|
| | | point | point | [g cm⁻³] |
| Silane | Formula | [° C.] | [° C.] | (at 25° C.) |
| Silane | SiH₄ | −112 | −185 | gas |
| Disilane | Si₂H₆ | −14 | −132 | gas |
| Trisilane | Si₃H₈ | 53 | −117 | 0.743 |
| Tetrasilane | Si₄H₁₀ | 108 | −90 | 0.793 |
| n-Pentasilane | Si₅H₁₂ | 153 | −72.8 | 0.827 |
| cyclopentasilane | Si₅H₁₀ | 194 | −10.5 | 0.963 |
| n-Hexasilane | Si₆H₁₄ | 193.6 | −44.7 | 0.847 |
| Cyclohexasilan | Si₆H₁₂ | 226 | 18 | 0.97 |

Their chemical formulas are given in the following schematics:

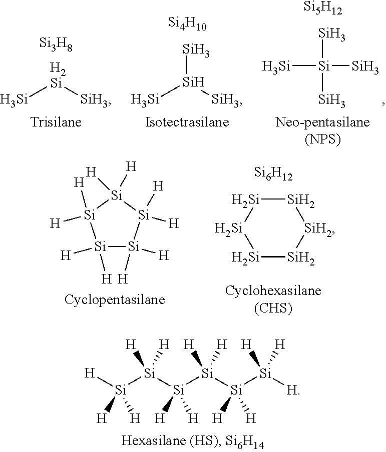

Non-limiting examples of the chemical derivatives of these silanes are decamethyl-Cyclopentasilane (C₁₀H₃₀Si₅), Hexabenzyl-cyclohexasilane, and tetradecamethyl-hexasilane (C₁₄H₄₂Si₆).

The Si deposition process can begin with impregnating the pores of porous host particles with a liquid silane. Among the various silanes, cyclohexasilane (CHS, Si₆H₁₂), Hexasilane (HS, Si₆H₁₄), Neo-pentasilane (NPS), Cyclopentasilane, and Tectrasilane are particularly useful because hey maintains a low vapor pressure and are stable in ambient light. They can be used for the solution-based synthesis of functional Si coating or particles inside pores. Using CHS as an example, the silane undergoes a ring-opening polymerization when exposed to heat or UV light, with thermal annealing transforming the polyhydrosilane to silicon. Liquid silane impregnation may be achieved by immersing the porous host particles in liquid silane (e.g., CHS) at room temperature. The liquid, before and after impregnation, may be exposed to UV irradiation to initiate ring-opening polymerization into polysilane, denoted [—Si(H₂)—]n. Presumably, some of the UV-initiated reactive species can permeate into pores of the host particles. The porous host particles containing polysilane in the pores can then be annealed at a higher temperature (e.g., 200-550° C.) for 0.5-4 hours to transform the polysilane into amorphous silicon coating or particles through the elimination of excess hydrogen. The particulates were then subjected to tube furnace annealing at an even higher temperature (e.g., >) 550° C. for 0.5-3 hours in a nitrogen atmosphere to induce further desorption of hydrogen, followed by a higher temperature heat treatment at 800-1,200° C. for 0.5-2 h. High-energy radiation exposure, such as electron beam, X-ray, and Gama ray, may be used to replace or augment UV for Si deposition.

In general, the deposited Si coating or particles do not fully occupy the pores of a host particle, allowing a sufficient amount of voids to accommodate the volume expansion of Si during the battery charging procedure. Most preferably, the residual pore-to-Si volume ratio is from 0.5 to 5.0, further preferably from 1.0 to 4.0. The Si coating or Si particles preferably have a thickness or diameter from 2 nm to 1 μm, more preferably from 10 nm to 500 nm and further preferably from 20 nm to 150 nm.

It may be noted that presumably the same or a similar process or apparatus can be implemented to deposit a Si film onto an anode current collector (e.g., a Cu foil) to directly produce an anode (negative electrode). However, given a desirable or economically viable length of time, the deposited Si film tends to be too thin to have a high specific areal capacity (mAh/cm²). In contrast, the presently disclosed particulates are in a powder form that can be readily incorporated with an optional binder and optional conductive additive to form an anode (negative electrode) of high areal capacity, typically higher than 4.5 mAh/cm², more typically higher than 6 mAh/cm², further typically and desirably higher than 10 mAh/cm², still more typically and desirably higher than 20 mAh/cm². 30 mAh/cm², 50 mAh/cm², etc. These high areal capacities normally could not be achieved if one chooses to deposit pure Si directly on a current collector.

The porous host particles are preferably selected from carbonaceous, graphitic, graphene, or metallic particles. The preparation of porous metallic particles is well-known in the art. For instance, one may mix or alloy a metal element A (e.g., Sn) with a sacrificial element Z or ingredient of multi-elements to form particles of A-Z alloy or mixture. The element Z is then chemically etched away, leaving behind pores in the Sn particles.

The porous graphene particles preferably comprise graphene sheets selected from pristine graphene, graphene fluoride, graphene chloride, graphene bromide, graphene iodide, nitrogenated graphene, hydrogenated graphene, doped graphene, chemically functionalized graphene, graphene oxide, reduced graphene oxide, or a combination thereof. The production of these graphene materials is well-known in the art.

The porous carbonaceous or graphitic particles preferably comprise porous particles of activated carbon, soft carbon (defined as a carbon material that is graphitizable), hard carbon (carbon material not graphitizable even at a temperature higher than 2,500° C.), polymeric carbon, activated natural graphite, activated artificial graphite, exfoliated graphite worms, expanded graphite flakes, meso-phase carbon, needle coke, or a combination thereof.

In some embodiments, step (c) is followed by a procedure of prelithiating the multiple Si-containing anode material particulates, wherein the anode material (Si) is prelithiated to contain an amount of lithium from 1% to 100% of a maximum lithium content contained in said anode active material.

The anode active material (Si) on the pore walls of porous host particles may be prelithiated before or after the anode fabrication, for the purpose of improving the first-cycle efficiency of a resulting lithium-ion cell. Prelithiation of anode active materials, such as Si, Ge, and Sn, can be accomplished in several different ways that can be classified into 3 categories: physical methods, electrochemical methods, and chemical methods. The chemical methods are typically conducted by sourcing lithium atoms from active reactants or lithium metal. The active reactants can include organometallic compounds and lithium salts and the reactions can be effectuated ex-situ (in a chemical reactor before anode fabrication, or after anode fabrication but before cell assembly). One may also bring lithium metal in direct contact with particles of the desired anode active material in a dry condition or with the presence of a liquid electrolyte.

A physical process entails depositing a Li coating on a surface of an anode active material substrate (e.g., a layer of Si-containing particles), followed by promoting thermally induced diffusion of Li into the substrate (e.g., into the interior of a Si deposited on pore walls of host particles). A thin lithium layer can be deposited on the surface of an anode material substrate using a standard thin film process, such as thermal evaporation, electron beam evaporation, sputtering, and laser ablation. A vacuum is preferably used during the deposition process to avoid reactivity between the atomic lithium and molecules of lithium-reactive substances such as water, oxygen, and nitrogen. A vacuum of greater than 1 milli-Torr is desirable. When electron beam deposition is used a vacuum of 10⁻⁴ Torr is desired and a vacuum of 10⁻⁶ Torr is preferred to avoid interaction between the electron beam and any residual air molecules.

The evaporative deposition techniques involve the heating of a lithium metal to create a lithium vapor. The lithium metal can be heated by an electron beam or by resistive heating of the lithium metal. The lithium vapor deposits lithium onto a substrate composed of packed Si-containing particles. To promote the deposition of lithium metal the substrate can be cooled or maintained at a temperature lower than the temperature of the lithium vapor. A thickness monitor such as a quartz crystal type monitor can be placed near the substrate to monitor the thickness of the film being deposited. Alternatively, laser ablation and sputtering techniques can be used to promote thin lithium film growth on a substrate. For example, argon ions can be used in the sputtering process to bombard a solid lithium metal target. The bombarding knocks lithium off of the target and deposits it on the surface of a substrate. Laser ablation processes can be used to knock lithium off of a lithium target. The separated lithium atoms are then deposited onto the substrate. The lithium-coated layer of packed Si-containing particles is then immersed into a liquid electrolyte containing a lithium salt dissolved in an organic solvent. Lithium atoms rapidly permeate into the bulk of Si particles to form prelithiated Si particles. Physical methods may also be conducted by simply mixing molten lithium metal with the anode particulates.

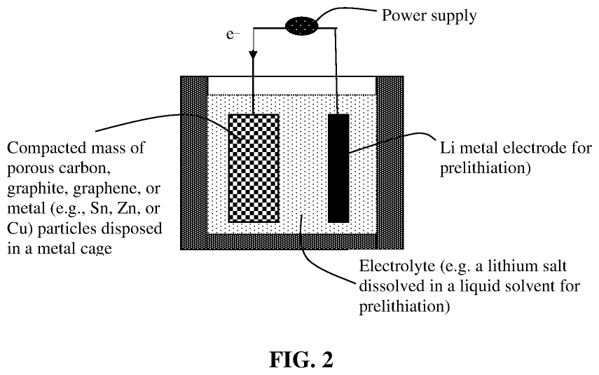

A more preferred pre-lithiation process involves electro-chemically forcing Li atoms to migrate into Si coating under the influence of an electromotive force (emf). In a typical arrangement, again using Si as an example, a compacted mass of Si-containing porous particulates is used as a positive electrode and Li metal sheet or rod as a negative electrode, in a chamber similar to what is illustrated in FIG. 2. The two electrodes are then immersed in a liquid electrolyte containing a lithium salt dissolved in an organic solvent. An electric current is then applied between the anode and the cathode. This is similar to an electro-plating procedure, but, surprisingly, Li atoms are capable of permeating into the bulk of the Si coating. For electro-chemical lithiation of Si, the Si-containing porous particulates may be confined in a porous container (e.g., fine metal mesh) that is permeable to electrolyte, but does not allow solid Si-containing particulates to escape. The fine metal mesh serves as a working electrode while a lithium metal rod or sheet serves as a counter electrode. The entire set-up is preferably immersed in a liquid electrolyte contained in an electrochemical reactor.

Preferably, the lithium salt in the liquid electrolyte is selected from lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), or a combination thereof. It may be noted that these metal salts are also commonly used in the electrolytes of rechargeable lithium batteries.

The electrolytes used in this electrochemical reactor may contain a solvent selected from 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfone, sulfolane, ethylene carbonate (EC), dimethyl carbonate (DMC), methylethyl carbonate (MEC), diethyl carbonate (DEC), ethyl propionate, methyl propionate, propylene carbonate (PC), gamma-butyrolactone (Y-BL), acetonitrile (AN), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), a hydrofluoroether, a room temperature ionic liquid solvent, or a combination thereof. These solvents are also commonly used in the electrolytes of rechargeable lithium batteries.

The anode active material (silicon) may be prelithiated to the extent that the porous particulates comprise a prelithiated silicon Li₄Si, Li_{4,4}Si, or LiₓSi, wherein numerical x is between 1 and 4.4.

The prelithiated anode active material particles may be subsequently subjected to a surface treatment that produces a surface-stabilizing coating to embrace the prelithiated particles, wherein this surface-stabilizing coating is a layer of lithium- or sodium-containing species that are chemically bonded to the prelithiated particles.

These bonding species (lithium- or sodium-containing species) can be simply generated as the products or by-products of select chemical or electrochemical reactions between the electrolyte (Li or Na salt dissolved in a solvent) and the anode active material particle surfaces (where elements such as C. O. H, and N are often present or prescribed to exist). These reactions may be preferably induced by externally applied current/voltage in an electrochemical reactor. This will be discussed in more detail later. The following procedure for producing surface stabilizing species is applicable to both prelithiated and non-lithiated particles of an anode active material. There is no limitation on the type of anode materials; all types of anode active materials that can be used in a lithium battery anode can be protected or embraced by using this invented method.

In a preferred embodiment, the lithium- or sodium-containing species may be selected from Li₂CO₃, Li₂O, Li₂C₂O₄, LIOH, LIX, ROCO₂Li, HCOLI, ROLi, (ROCO₂Li)₂, (CH₂OCO₂Li)₂, Li₂S, LiₓSO_{y}, Li₄B, Na₄B, Na₂CO₃, Na₂O, Na₂C₂O₄, NaOH, NaX, ROCO₂Na, HCONa, RONa, (ROCO₂Na)₂. (CH₂OCO₂Na)₂. Na₂S, NaₓSO_{y}, or a combination thereof, wherein X=F. Cl, I, or Br, R=a hydrocarbon group (e.g. R=CH—, CH₂—, CH₃CH₂—, etc.), x=0−1, y=1−4. These species are surprisingly capable of chemically bonding to surfaces of various anode active material particles to form a structurally sound encapsulating layer. Such a layer is also permeable to lithium ions, enabling subsequent lithium intercalation/insertion and de-intercalation/extraction into/from the protected particles. Typically, not just one, but at least two types of lithium- or sodium-containing species in the above list are present in the protective layer embracing the prelithiated or non-lithiated particles if this layer is produced electrochemically.

The preparation of the surface-protecting layers containing these lithium- or sodium-containing species may be conducted in an electrochemical reactor, which is an apparatus very similar to an electrode plating system. In this reactor, an anode material-containing porous structure (in the form of a mat, paper, film, etc. or simply in a compacted mass confined by a mess of conducting wires) is used as a working electrode and lithium sheet (or sodium sheet) as a counter electrode. Contained in the reactor is an electrolyte composed of a lithium or sodium salt dissolved in a solvent (e.g. 1M LiPF₆ dissolved in a mixture of ethylene carbonate (EC) and dimethyl carbonate (DMC) at a 1:1 ratio by volume). A current is then imposed between these two electrodes (lithium or sodium sheet electrode and the anode active material-based working electrode). The particles of the anode active material in the working electrode are galvanostatically discharged (e.g. Li ions being sent to and inserted into the anode active material particles) and charged (Li ions released by these particles) in the voltage range from 0.01V to 4.9V at the current densities of 100-1000 mA/g following a voltage-current program similar to what would be used in a lithium-ion battery. However, the system is intentionally subjected to conditions conducive to oxidative degradation of electrolyte (e.g. close to 0.01-1.0 V vs. Li/Li⁺) or reductive degradation of electrolyte (4.1-4.9 V vs. Li/Li⁺) for a sufficient length of time. The degradation products react with Li⁺ ions, Li salt, functional groups (if any) or carbon atoms coated on particles to form the lithium-containing species that also chemically bond to the particles.

The chemical compositions of the lithium-containing species are governed by the voltage range, the number of cycles (from 0.01 V to 4.9 V, and back), solvent type, lithium salt type, chemical composition of graphene sheets (e.g. % of O. H, and N), and electrolyte additives (e.g. LiNO₃, if available). The morphology, structure and composition of graphene oxide (GO), reduced graphene oxide (RGO), the lithium-containing species that are bonded to graphene sheets can be characterized by scanning electron microscope (SEM), transmission electron microscope (TEM), Raman spectrum, X-ray diffraction (XRD), Fourier Transform Infrared Spectroscopy (FTIR), elemental analysis, and X-ray photoelectron spectroscopy (XPS).

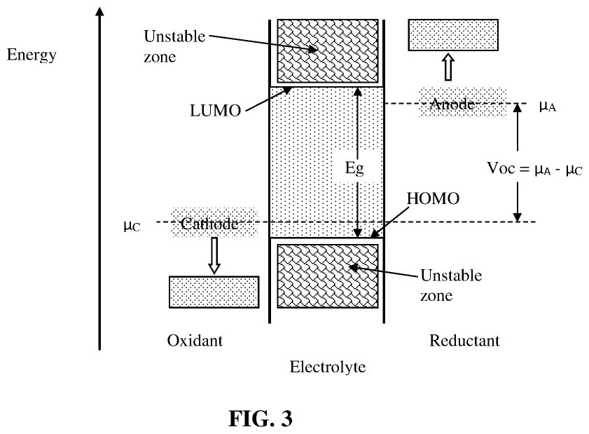

The decomposition of non-aqueous electrolyte leads to the formation of lithium or sodium chemical compounds that bond to graphene surfaces and edges. The reasons why the non-aqueous electrolyte decomposed during discharge-charge cycling in an electrochemical reactor may be explained as follows. As illustrated in FIG. 3, in an electrochemical reactor system where there are a cathode and an anode in contact with an electrolyte, the thermodynamic stability of the electrolyte is dictated by the relative electron energies of the two electrodes relative to the energy level of the non-aqueous electrolyte. The anode is potentially a reductant, and the cathode an oxidant. The two electrodes are typically electronic conductors and, in this diagram, their electrochemical potential are designated as μ_{A} and μ_{C} (or Fermi energies ε_{F}), respectively. The energy separation, E_{g}, between the lowest unoccupied molecular orbital (LUMO) and the highest occupied molecular orbital (HOMO) of the electrolyte is the stable electrochemical window of the electrolyte. In other words, in order for the electrolyte to remain thermodynamically stable (i.e. not to decompose), the electrochemical potential of the anode (HA) should be maintained below the LOMO and pc of the cathode should be above the HOMO.

From the schematic diagram of FIG. 3, we can see that an anode with HA above the LUMO and a cathode with pc below the HOMO will reduce and oxidize the electrolyte, respectively, unless a passivating film is formed that creates a barrier to electron transfer between the anode and the electrolyte or between the cathode and the electrolyte. In the presently invented method, an external current/voltage is intentionally applied over the anode and the cathode to bias their respective electrochemical potential levels so that the electrolyte can go outside of the stable electrochemical potential window, undergoing oxidative and/or reductive degradation. The degradation products are reactive species that react among themselves and with the functional groups or active atoms on particles of the anode active material or their surface coverage layer (carbon, graphene, conductive polymers, etc.), forming a mass of lithium- or sodium-containing species that bond to surfaces of these particles (with or without a surface coverage.

For the list of lithium/sodium salts and solvents investigated, the electrolytes have an oxidation potential (HOMO) at about 4.7 V and a reduction potential (LUMO) near 1.0 V. (All voltages in this specification are with respect to Li⁺/Li or Na⁺/Na). We have observed that the chemical interaction of Li⁺ or Na⁺ ions with particles of an anode active material (with or without carbon or graphene coverage) typically occur at about 0.01-0.8 V, so electrolytes are prone to reductive degradation in the voltage range of 0.01-0.8 V. By imposing a voltage close to 4.7 volts, the electrolytes are also subject to oxidative degradation. The degradation products spontaneously react with chemical species associated with these particles, forming a protective layer embracing/encapsulating these particles during the charge-discharge cycling (electrolyte reduction-oxidation cycling). In general, these lithium- or sodium-containing species are not electrically conducting and, hence, these reactions can self-terminate to form essentially a passivating phase.

The electrolytes that can be used in this electrochemical decomposition reactor may be selected from any lithium or sodium metal salt that is dissolvable in a solvent to produce an electrolyte. Preferably, the metal salt is selected from lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), sodium perchlorate (NaClO₄), sodium hexafluorophosphate (NaPF₆), sodium borofluoride (NaBF₄), sodium trifluoro-metasulfonate (NaCF₃SO₃), bis-trifluoromethyl sulfonylimide sodium (NaN(CF₃SO₂)₂), sodium trifluoromethanesulfonimide (NaTFSI), bis-trifluoromethyl sulfonylimide sodium (NaN(CF₃SO₂)₂), or a combination thereof. It may be noted that these metal salts are also commonly used in the electrolytes of rechargeable lithium or sodium batteries.

The electrolytes used in this electrochemical decomposition reactor may contain a solvent selected from 1,3-dioxolane (DOL), 1,2-dimethoxyethane (DME), tetracthylene glycol dimethylether (TEGDME), poly(ethylene glycol) dimethyl ether (PEGDME), diethylene glycol dibutyl ether (DEGDBE), 2-ethoxyethyl ether (EEE), sulfone, sulfolane, ethylene carbonate (EC), dimethyl carbonate (DMC), methylethyl carbonate (MEC), diethyl carbonate (DEC), ethyl propionate, methyl propionate, propylene carbonate (PC), gamma-butyrolactone (Y-BL), acetonitrile (AN), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), a hydrofluoroether, a room temperature ionic liquid solvent, or a combination thereof. These solvents are also commonly used in the electrolytes of rechargeable lithium or sodium batteries.

It may be noted that the electrochemical decomposition reactor used for the formation of a surface protection layer may be the same electrochemical reactor for prelithiation. As illustrated in FIG. 2, the prelithiation process may be allowed to proceed at a current/voltage condition that is in favor of electrochemically inserting lithium ions into the anode active material particles (this condition being in the thermodynamic stability regions depicted in FIG. 3). For example, the voltage difference between the working electrode (containing Si particles, for instance) and the counter electrode may be cycled between 0.6 volts and 3.3 volts for prelithiation of Si. Following this prelithiation procedure, the voltage difference is then cycled between 0.1 volts and 4.8 volts (as an example) to effectuate electrochemical decomposition of the electrode for forming the Li- and/or Na-containing species. The electrolyte used in prelithiation can be the same as or different than the electrolyte used for protective species formation.

The protective layer of the instant invention typically exhibits a lithium ion or sodium ion conductivity from 2.5×10⁻⁵ S/cm to 5.5×10⁻³ S/cm, and more typically from 1.0×10⁻⁴ S/cm to 2.5×10⁻³ S/cm. The anode active material may be made into a thin film and then the Li- or Na-containing species are coated thereon and then peeled off to allow for ion conductivity measurement.

Several micro-encapsulation processes can be used to embrace/encapsulate particles of an anode active material (with or without prelithiation) with a protective layer. This preferably requires dissolution of a lithium salt, a sodium salt, multiple lithium salts, and/or multiple sodium salts in a solvent (including mixture of multiple solvents) to form a solution. This solution can then be used to encapsulate solid particles via several of the micro-encapsulation methods to be discussed in what follows. The same type of encapsulation processes may be used to encapsulate the disclosed porous conducting host particles containing an anode active material deposited therein, with or without prelithiation.

There are three broad categories of micro-encapsulation methods that can be implemented to produce encapsulated particles of an anode active material: physical methods, physico-chemical methods, and chemical methods. The physical methods include pan-coating, air-suspension coating, centrifugal extrusion, vibration nozzle, and spray-drying methods. The physico-chemical methods include ionotropic gelation and coacervation-phase separation methods. The chemical methods include interfacial polycondensation or other surface reactions. Several methods are discussed below as examples.

Pan-coating method: The pan coating process involves tumbling the active material particles in a pan or a similar device while the encapsulating material (e.g. highly concentrated solution of Li/Na salts in a solvent) is applied slowly until a desired encapsulating shell thickness is attained.

Air-suspension coating method: In the air suspension coating process, the solid particles (core material) are dispersed into the supporting air stream in an encapsulating chamber. A controlled stream of a salt-solvent solution (with an optional polymer) is concurrently introduced into this chamber, allowing the solution to hit and coat the suspended particles. These suspended particles are encapsulated (fully coated) with the salts while the volatile solvent is removed, leaving a very thin layer of Li and/or Na salts on surfaces of these particles. This process may be repeated several times until the required parameters, such as full-coating thickness (i.e. encapsulating shell or wall thickness), are achieved. The air stream which supports the particles also helps to dry them, and the rate of drying is directly proportional to the temperature of the air stream, which can be adjusted for optimized shell thickness.

In a preferred mode, the particles in the encapsulating zone portion may be subjected to re-circulation for repeated coating. Preferably, the encapsulating chamber is arranged such that the particles pass upwards through the encapsulating zone, then are dispersed into slower moving air and sink back to the base of the encapsulating chamber, enabling repeated passes of the particles through the encapsulating zone until the desired encapsulating shell thickness is achieved.

Centrifugal extrusion: Anode active materials may be encapsulated using a rotating extrusion head containing concentric nozzles. In this process, a stream of core fluid (slurry containing particles of an anode active material dispersed in a solvent) is surrounded by a sheath of shell solution or melt. As the device rotates and the stream moves through the air it breaks, due to Rayleigh instability, into droplets of core, each coated with the shell solution. While the droplets are in flight, the molten shell may be hardened or the solvent may be evaporated from the shell solution. If needed, the capsules can be hardened after formation by catching them in a hardening bath. Since the drops are formed by the breakup of a liquid stream, the process is only suitable for liquid or slurry. A high production rate can be achieved. Up to 22.5 kg of microcapsules can be produced per nozzle per hour and extrusion heads containing 16 nozzles are readily available.

Vibrational nozzle method: Core-shell encapsulation of an anode active material can be conducted using a laminar flow through a nozzle and vibration of the nozzle or the liquid. The vibration has to be done in resonance with the Rayleigh instability, leading to very uniform droplets. The liquid can include any liquids with limited viscosities (1-50,000 mPa·s): emulsions, suspensions or slurry containing the anode active material. The solidification can be done according to the used gelation system with an internal gelation (e.g. sol-gel processing, melt) or an external (additional binder system, e.g. in a slurry).

Spray-drying: Spray drying may be used to encapsulate particles of an active material when the active material is dissolved or suspended in a melt or polymer solution. In spray drying, the liquid feed (solution or suspension) is atomized to form droplets which, upon contacts with hot gas, allow solvent to get vaporized and thin polymer shell to fully embrace the solid particles of the active material.

It may be noted that the anode active material (e.g., prelithiated or non-lithiated particulates) may be coated with a carbonizable coating material (e.g., phenolic resin, poly(furfuryl alcohol), coal tar pitch, or petroleum pitch). The coating can then be carbonized to produce an amorphous carbon or polymeric carbon coating on the surface of these particulates. Such a conductive surface coating can help maintain a network of electron-conducting paths during repeated charge/discharge cycles and prevent undesirable chemical reactions between Si and electrolyte from happening. Hence, the presently invented method may further comprise a step of coating a surface of the particulates with a thin layer of carbon having a thickness less than 1 μm. The thin layer of carbon preferably has a thickness less than 100 nm. Such a thin layer of carbon may be obtained from pyrolization of a polymer, pitch, or organic precursor or obtained by chemical vapor deposition, physical vapor deposition, sputtering, etc.

Alternatively, the particulates containing an anode active material therein may be coated with a layer of electron-conducting polymer or ion-conducting polymer. Such coating processes are well-known in the art.

The surface-stabilized or surface-stabilized and prelithiated particles of an anode active material (with or without a coating of carbon, graphene, electron-conducting polymer, or ion-conducting polymer) may be further encapsulated by a thin layer of a high-elasticity polymer (e.g. an elastomer) having a fully recoverable tensile strain of from 5% to 700% and a thickness preferably from 0.5 nm to 2 μm (preferably from 1 nm to 100 nm). The elastomer preferably has a lithium ion conductivity from 10⁻⁷ S/cm to 5×10⁻² S/cm at room temperature (preferably and typically no less than 10⁻⁶ S/cm, further preferably no less than 10⁻⁵ S/cm, more preferably no less than 10⁻⁴ S/cm, and most preferably no less than 10⁻³ S/cm).

In others, the elastomeric material is an elastomer matrix composite containing from 0.1% to 50% by weight (preferably from 1% to 35% by weight) of a lithium ion-conducting additive dispersed in an elastomer matrix material.

In some embodiments, the elastomeric material contains a material selected from natural polyisoprene (e.g. cis-1,4-polyisoprene natural rubber (NR) and trans-1,4-polyisoprene gutta-percha), synthetic polyisoprene (IR for isoprene rubber), polybutadiene (BR for butadiene rubber), chloroprene rubber (CR), polychloroprene (e.g. Neoprene, Baypren etc.), butyl rubber (copolymer of isobutylene and isoprene, IIR), including halogenated butyl rubbers (chloro butyl rubber (CIIR) and bromo butyl rubber (BIIR), styrene-butadiene rubber (copolymer of styrene and butadiene, SBR), nitrile rubber (copolymer of butadiene and acrylonitrile, NBR), EPM (ethylene propylene rubber, a copolymer of ethylene and propylene), EPDM rubber (ethylene propylene diene rubber, a terpolymer of ethylene, propylene and a diene-component), epichlorohydrin rubber (ECO), polyacrylic rubber (ACM, ABR), silicone rubber (SI, Q. VMQ), fluorosilicone rubber (FVMQ), fluoroclastomers (FKM, and FEPM; such as Viton, Tecnoflon, Fluorel, Aflas and Dai-El), perfluoroelastomers (FFKM: Tecnoflon PFR, Kalrez, Chemraz, Perlast), polyether block amides (PEBA), chlorosulfonated polyethylene (CSM; e.g. Hypalon), and ethylene-vinyl acetate (EVA), thermoplastic elastomers (TPE), protein resilin, protein elastin, ethylene oxide-epichlorohydrin copolymer, polyurethane, urethane-urea copolymer, and combinations thereof.

The urethane-urea copolymer film usually includes two types of domains, soft domains and hard ones. Entangled linear backbone chains including poly(tetramethylene ether) glycol (PTMEG) units constitute the soft domains, while repeated methylene diphenyl diisocyanate (MDI) and ethylene diamine (EDA) units constitute the hard domains. The lithium ion-conducting additive can be incorporated in the soft domains or other more amorphous zones.

In some embodiments, the elastomeric material is an elastomer matrix composite containing a lithium ion-conducting additive dispersed in an elastomer matrix material, wherein said lithium ion-conducting additive is selected from Li₂CO₃, Li₂O, Li₂C₂O₄, LiOH, LIX, ROCO₂Li, HCOLi, ROLi, (ROCO₂Li)₂. (CH₂OCO₂Li)₂, Li₂S, LiₓSO_{y}, or a combination thereof, wherein X=F, Cl, I, or Br, R=a hydrocarbon group, x=0−1, y=1−4.

In some embodiments, the elastomeric material is an elastomer matrix composite containing a lithium ion-conducting additive dispersed in an elastomer matrix material, wherein said lithium ion-conducting additive contains a lithium salt selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, or a combination thereof.

The elastomeric material may contain a mixture or blend of an elastomer and an electron-conducting polymer selected from polyaniline, polypyrrole, polythiophene, polyfuran, a bi-cyclic polymer, derivatives thereof (e.g. sulfonated versions), or a combination thereof.

In some embodiments, the elastomeric material contains a mixture or blend of an elastomer and a lithium ion-conducting polymer selected from poly(ethylene oxide) (PEO), Polypropylene oxide (PPO), poly(acrylonitrile) (PAN), poly(methyl methacrylate) (PMMA), poly(vinylidene fluoride) (PVdF), Poly bis-methoxy ethoxyethoxide-phosphazenex, Polyvinyl chloride, Polydimethylsiloxane, poly(vinylidene fluoride)-hexafluoropropylene (PVDF-HFP), a derivative thereof (e.g. sulfonated versions), or a combination thereof.

In the preparation of an anode electrode, acetylene black(AB), carbon black (CB), or ultra-fine graphite particles may be used as a conductive additive. Conductive additives may comprise an electrically conductive material selected from the group consisting of electro-spun nano fibers, carbonized electro-spun nano fibers, vapor-grown carbon or graphite nano fibers, carbon or graphite whiskers, carbon nano-tubes, nano-scaled graphene platelets, metal nano wires, metal-coated nano wires, carbon-coated nano wires, metal-coated nano fibers, carbon-coated nano fibers, and combinations thereof. A binder material may be chosen from polytetrafluoroethylene (PTFE), polyvinylidene fluoride (PVDF), ethylene-propylene-diene copolymer (EPDM), or styrene-butadiene rubber (SBR), for example. Conductive materials such as electronically conductive polymers, meso-phase pitch, coal tar pitch, and petroleum pitch may also be used as a binder. A typical mixing ratio of these ingredients is 80 to 85% by weight for the anode active material, 5 to 15% by weight for the conductive additive, and 5 to 10% by weight for the binder. The current collector may be selected from aluminum foil, stainless steel foil, and nickel foil. There is no particularly significant restriction on the type of current collector, provided the material is a good electrical conductor and relatively corrosion resistant. The separator may be selected from a polymeric nonwoven fabric, porous polyethylene film, porous polypropylene film, or porous PTFE film.

The electrode fabrication may comprise combining multiple porous conductive particles (containing solution-deposited Si, with or without prelithiation) with a conductive additive and/or a binder material and, in certain embodiments, plus a desired amount of another type of anode active materials selected from particles of graphite, hard carbon, soft carbon, meso-carbon micro-bead, surface-modified graphite, carbon-coated graphite, or a combination thereof.

Hence, a lithium ion battery may contain an anode that comprises one or at least two types of anode active material wherein at least one type of active material is prelithiated (e.g., Si and Sn) and at least one type of active material is not prelithiated (e.g., carbonaceous material, such as graphite, hard carbon, soft carbon, surface-modified graphite, chemically modified graphite, or meso-carbon micro-beads, MCMBs). Prelithiated carbonaceous anode materials are unstable in regular room air. The present invention enable the battery to contain an anode that comprises at least a non-carbon active material possessing an ultra-high lithium absorbing capacity (e.g., Si that exhibits a specific capacity up to 4,200 mAh/g). The battery comprises an anode that contains an excess amount of lithium (disposed inside a non-carbon anode active material, not on its surface) to compensate for the formation of SEI layers, in addition to providing enough lithium to intercalate into (or form a compound with) a cathode active material.

The present invention allows the excess amount of lithium to be stored in high-capacity anode active materials (there is no need to make use of the full capacity of Si, for instance). The capacity limitation is on the cathode side, rather than the anode side. The present approach obviates the need for the cathode to supply the needed lithium, thereby further reducing the needed initial weight of the cathode or increasing the cathode weight that can be incorporated in a cell. This strategy can increase the overall capacity of a lithium ion battery by another 10%-20%.

There is no limitation on the types of cathode materials that can pair up with the presently invented anode materials. The positive electrode active material may be selected from a wide variety of oxides, such as lithium-containing nickel oxide, lithium-containing cobalt oxide, lithium-containing nickel-cobalt oxide, lithium-containing vanadium oxide, lithium iron phosphate, lithium manganese phosphate, lithium manganese-iron phosphate, and other lithium metal (or mixed metals) phosphate. Positive electrode active material may also be selected from chalcogen compounds, such as titanium disulfate or molybdenum disulfate. More preferred are lithium cobalt oxide (e.g., LiₓCoO₂ where 0.8≤x≤1), lithium nickel oxide (e.g., LiNiO₂), lithium manganese oxide (e.g., LiMn₂O₄ and LiMnO₂), lithium iron phosphate, lithium manganese-iron phosphate, lithium vanadium phosphate because these oxides provide a relatively high cell voltage and relatively good cycling stability.

Lithium cobalt oxide (LiCoO₂) is one of the most important cathode materials used in lithium-ion secondary batteries. LiCoO₂ and other similar lithium transition metal oxides, such as lithium manganese oxide, lithium nickel oxide, and lithium vanadium oxide, can be prepared by various methods using different lithium and transition metal sources. In general, bulk transition metal oxides are prepared by solid-state reactions, which involve repeated heat processes at high temperatures. Such processes generally afford the thermodynamically more stable phases and in general, microcrystalline materials are obtained. Lower temperatures and mild processing conditions may be used for several methods, such as co-precipitation, sol-gel process with/without template, synthesis by precursor, ion-exchange reaction and hydrothermal. These methods also result in particles with better control of morphology and smaller size. Other methods include flame spray pyrolysis, dehydro-freezing evaporation, supercritical dehydration, supersonic hydrothermal synthesis, and ultrasonic processing.

As an example, a process for producing lithium-cobalt oxide my include (a) mixing cobalt oxide having an average particle size of not more than 0.1 μm, with a lithium compound; and (b) calcining the obtained mixture at a temperature of 500 to 850° C. As compared to the conventional processes that begin with larger cobalt oxide particles (e.g., diameter >10 μm), such a process is advantageous in that lithium-cobalt oxide particles (1) can be produced with a short calcination time, (2) have a narrow particle size distribution, and (3) have a uniform small particle size.

The flame-spray pyrolysis method may include the steps of: (a) spraying minute droplets containing a solution of dissolved lithium salt and cobalt salt at room temperature; (b) atomizing the minute droplets through rapid expansion into a high temperature environment generated by combusting oxygen and hydrogen; (c) decomposing and oxidizing the atomized minute droplets thermally at high temperature to produce nano-sized oxides in gaseous phase; and (d) collecting the produced nano-sized composite oxides particles.

Lithium iron phosphate LiFePO₄ is a promising candidate of cathode material for lithium-ion batteries. The advantages of LiFePO₄ as a cathode active material includes a high theoretical capacity (170 mAh/g), environmental benignity, low resource cost, good cycling stability, high temperature capability, and prospect for a safer cell compared with LiCoO₂. A major drawback with this material is that it has very low electronic conductivity, on the order of 10⁻⁹ S/cm². This renders it difficult to prepare cathodes capable of operating at high rates. In addition, poor solid-phase transport means that the utilization of the active material is a strong function of the particle size. This major problem may be overcome by using a nano-scaled powder (to reduce the Li ion diffusion path and electron transport path distance) and doping the powder with a transition metal. Lithium iron phosphate (LiFePO₄) nano particles may be prepared by ball milling of conventional micron-sized particles, which may be prepared by a solid state reaction using LiOH. H₂O, (CH₃COO)₂Fc, and NH₄H₂PO₄ as raw materials. Additionally, Li_{1.3}Al_{0.3}Ti_{1.7}(PO₄)₃ materials, as an example of lithium mixed-metal phosphate, may be successfully prepared by the solution deposition using lithium acetate, aluminum nitrate, ammonium dihydrogen phosphate and titanium butoxide as starting materials. The resulting material may be ball-milled to sub-micron or nanometer scales. This is but one example of a host of complex metal phosphate-based cathode materials.

A wide range of electrolytes can be incorporated into the lithium cells. Most preferred are non-aqueous and polymer gel electrolytes although other types can be used. The non-aqueous electrolyte to be employed herein may be produced by dissolving an electrolytic salt in a non-aqueous solvent. Any known non-aqueous solvent which has been employed as a solvent for a lithium secondary battery can be employed. A non-aqueous solvent mainly including of a mixed solvent comprising ethylene carbonate (EC) and at least one kind of non-aqueous solvent whose melting point is lower than that of aforementioned ethylene carbonate (hereinafter referred to as a second solvent) may be preferably employed. This non-aqueous solvent is advantageous in that it is (a) stable against a negative electrode containing a carbonaceous material well developed in graphite structure; (b) effective in suppressing the reductive or oxidative decomposition of electrolyte; and (c) high in conductivity. A non-aqueous electrolyte solely composed of ethylene carbonate (EC) is advantageous in that it is relatively stable against decomposition through a reduction by a graphitized carbonaceous material. However, the melting point of EC is relatively high, 39 to 40° C., and the viscosity thereof is relatively high, so that the conductivity thereof is low, thus making EC alone unsuited for use as a secondary battery electrolyte to be operated at room temperature or lower. The second solvent to be used in a mixture with EC functions to make the viscosity of the solvent mixture lower than that of EC alone, thereby promoting the ion conductivity of the mixed solvent. Furthermore, when the second solvent having a donor number of 18 or less (the donor number of ethylene carbonate is 16.4) is employed, the aforementioned ethylene carbonate can be easily and selectively solvated with lithium ion, so that the reduction reaction of the second solvent with the carbonaceous material well developed in graphitization is assumed to be suppressed. Further, when the donor number of the second solvent is controlled to not more than 18, the oxidative decomposition potential to the lithium electrode can be easily increased to 4 V or more, so that it is possible to manufacture a lithium secondary battery of high voltage.

Preferable second solvents are dimethyl carbonate (DMC), methylethyl carbonate (MEC), diethyl carbonate (DEC), ethyl propionate, methyl propionate, propylene carbonate (PC), .gamma.-butyrolactone (.gamma.-BL), acetonitrile (AN), ethyl acetate (EA), propyl formate (PF), methyl formate (MF), toluene, xylene and methyl acetate (MA). These second solvents may be employed singly or in a combination of two or more. More desirably, this second solvent should be selected from those having a donor number of 16.5 or less. The viscosity of this second solvent should preferably be 28 cps or less at 25° C.

The mixing ratio of the aforementioned ethylene carbonate in the mixed solvent should preferably be 10 to 80% by volume. If the mixing ratio of the ethylene carbonate falls outside this range, the conductivity of the solvent may be lowered or the solvent tends to be more easily decomposed, thereby deteriorating the charge/discharge efficiency. More preferable mixing ratio of the ethylene carbonate is 20 to 75% by volume. When the mixing ratio of ethylene carbonate in a non-aqueous solvent is increased to 20% by volume or more, the solvating effect of ethylene carbonate to lithium ions will be facilitated and the solvent decomposition-inhibiting effect thereof can be improved.

Examples of preferred mixed solvent are a composition comprising EC and MEC; comprising EC, PC and MEC; comprising EC, MEC and DEC; comprising EC, MEC and DMC; and comprising EC, MEC, PC and DEC; with the volume ratio of MEC being controlled within the range of 30 to 80%. By selecting the volume ratio of MEC from the range of 30 to 80%, more preferably 40 to 70%, the conductivity of the solvent can be improved. With the purpose of suppressing the decomposition reaction of the solvent, an electrolyte having carbon dioxide dissolved therein may be employed, thereby effectively improving both the capacity and cycle life of the battery.

The electrolytic salts to be incorporated into a non-aqueous electrolyte may be selected from a lithium salt such as lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃) and bis-trifluoromethyl sulfonylimide lithium [LiN(CF₃SO₂)₂]. Among them, LiPF₆, LiBF₄ and LiN(CF₃SO₂)₂ are preferred. The content of aforementioned electrolytic salts in the non-aqueous solvent is preferably from 0.5 to 2.0 mol/l.

### EXAMPLE 1: Production of Porous Graphene Particles (Graphene Balls) from Flake Graphite and Si Deposition from Cyclohexasilane

In a representative procedure, 1 kg of polypropylene (PP) pellets, 50 grams of flake graphite, 50 mesh (average particle size 0.18 mm; Asbury Carbons, Asbury NJ) and 250 grams of magnetic steel balls were placed in a high-energy ball mill container. The ball mill was operated at 300 rpm for 2 hours. The container lid was removed and stainless steel balls were removed via a magnet. The polymer carrier material was found to be coated with a dark graphene layer. Carrier material was placed over a 50 mesh sieve and a small amount of unprocessed flake graphite was removed.

A sample of the coated carrier material was then submitted to air flow suspension in a heating chamber, wherein the graphene-coated PP particles were heat-treated at 350° C. and then at 600° C. for 2 hours to produce individual (isolated/separated) graphene balls.

In a separate experiment, the same batch of PP pellets and flake graphite particles (without the impacting steel balls) were placed in the same high-energy ball mill container and the ball mill was operated under the same conditions for the same period of time. The results were compared with those obtained from impacting ball-assisted operation. The graphene sheets isolated from PP particles, upon PP dissolution, are mostly single-layer graphene. The graphene balls produced from this process typically have a higher level of porosity (lower physical density).

After the porous graphene balls were prepared, they were impregnated with a liquid silane, cyclohexasilane (CHS, Si₆H₁₂), which maintains a low vapor pressure and is stable in ambient light. CHS is herein used for the solution-based synthesis of functional Si coating or particles. The CHS undergoes a ring-opening polymerization when exposed to heat or UV light, with thermal annealing transforming the polyhydrosilane to silicon. In the present study, porous graphene balls were immersed in liquid silane (CHS) at room temperature under simultaneous UV irradiation from a 500 W HgXe lamp to initiate ring-opening polymerization into polysilane, denoted [—Si(H₂)—]n. Presumably, some of the UV-initiated reactive species permeated into pores of the graphene balls. The porous graphene balls containing polysilane in the pores were then annealed at 400° C. for 1 h in a vacuum oven to transform the polysilane into amorphous silicon coating or particles through the elimination of excess hydrogen. The particulates were then subjected to tube furnace annealing at 550° C. for 1 h in a nitrogen atmosphere to induce further desorption of hydrogen, followed by a higher temperature heat treatment at 950° C. for 1 h.

### EXAMPLE 2: Production of Porous Graphene Particulates Using Expanded Graphite (>100 nm in Thickness) as the Graphene Source

In an experiment, 100 grams of acrylonitrile-butadiene-styrene copolymer (ABS) pellets, as the sacrificial material particles, were placed in a plastic container along with 5 grams of expanded graphite. This container was part of an attritor mill, which was operated for 30 minutes-2 hours. After processing, particles of the sacrificial material were found to be coated with a thin layer of graphene-like material. A small sample of graphene-coated sacrificial material was placed in acetone and subjected to ultrasound energy to speed dissolution of the ABS. The solution was filtered using an appropriate filter and washed four times with additional acetone. Subsequent to washing, filtrate was dried in a vacuum oven set at 60° C. for 2 hours. This sample was examined by optical microscopy and Raman spectroscopy, and found to be graphene.

The remaining graphene-coated ABS particles were then immersed in acetone, without ultrasonication, to produce graphene particulates, which were subjected to carbonization at 600-900° C.) for 2 hours to obtain porous particulates of different porosity levels.

For the study on the deposition of Si in the pores of these graphene particulates, the following chemicals were used: Bis[bis(trimethylsilyl)amino]tin(II) (Sn(hmds)₂), trisilane (Si₃H₈), isotetrasilane (Si₄H₁₀), neopentasilane (Si₅H₁₂), dodecylamine, squalane, and poly(vinylpyrrolidinone)-hexadecane (PVP-HDE) copolymer. PVP-HDE was dissolved in dodecylamine to make a 33% w/w copolymer solution. The copolymer solution and the squalane were degassed under vacuum at 80° C. for 45 min and then stored in a nitrogen-filled glovebox prior to use.

Si deposition in the pores was carried out using a Sn-seeded Si nanorod growth reaction. The reactions were carried out on a Schlenk line setup operated inside a nitrogen-filled glovebox. In a typical reaction, 10 mL of squalane was heated to 380° C. under N₂ flow in a flat bottom flask attached to the Schlenk line assembly.

Separately, a precursor solution of 1 mL of PVP-HDE/dodecylamine solution (containing 27.5 mg of PVP-HDE), 20 μL of Sn(hmds)₂, and 76 μL of trisilane was prepared in a vial at room temperature, which immediately turned dark brown after mixing due to the formation of Sn nanoparticles. A small amount of porous graphene particulates were immersed in the precursor solution during the mixing procedure. The mixture was then poured into the hot solvent. After 3 min, the reaction flask was removed from the heating mantle and allowed to cool to room temperature.

In two additional, separate reactions, the precursor solutions were made of 70 μL of isotetrasilane, 68 μL of neopentasilane, and 56 μL of cyclohexasilane, respectively, to maintain a consistent [Si] concentration in each reaction. Reaction temperatures ranging between 180° and 380° C. were investigated.

### EXAMPLE 3: Production of Activated Carbon by Chemical Activation of MCMBs by ZnCl₂. Followed by Deposition of Si in the Pores

We used two different amounts of starting material (400 g and 100 g). Other than this difference in starting amounts, all other variables were the same in the following activation procedures. The particles were impregnated with zinc chloride (ZnCl₂) at 1:1 wt. ratio and were kept at 80° C. for 14 h. Heat treatments were then carried out under constant nitrogen flow (5 1/h). The heat treatment temperature was raised at 4° C./min up to 500° C., which was maintained for 3 h. The samples were then washed to remove excess reagent and dried at 110° C. for about 3 h. The resulting samples were labeled as CA (chemically activated only). Part of these samples was then also submitted to physical activation. Temperature was raised to 900° C. at a rate of 25° C./min, under nitrogen flow. At 900° C., the samples were then contacted with steam (0.8 kg/h) for 30 min. These samples were then labeled as CAPA (both chemically and physically activated). It was observed that combined physical and chemical activation treatments led to a higher porosity level and slightly higher pore sizes that are more readily accessible to liquid electrolyte.

The Si deposition process was similar to that described in Example 1. After Si deposition, the porous AC particles containing Si coating therein were subjected to an electrochemical prelithiation treatment using an apparatus as illustrated in FIG. 2, but the liquid electrolyte contained 1M LiClO₄ dissolved in ethylene carbonate and the counter electrode was a piece of Li foil.

### EXAMPLE 4: Chemical Activation of MCMBs by KOH, NaOH, and their Mixtures and Deposition of Si in the Pores

In this example, several MCMB samples were separately mixed with KOH, NaOH, and their mixtures (30/70, 50/50, and 70/30 weight ratios) to obtain reactant blends. The blends were then heated to a desired temperature (in the range of 700-950° C.) and maintained at this temperature for 0.5-12 hours to produce various activated MCMB samples. The resulting structures vary with the previous heat treatment history of MCMBs, activation temperature, and activation time. The following observations were made:
1) The maximum heat treatment temperature (Tₘₐₓ) the MCMBs saw prior to the chemical activation dictates the number of graphene planes in graphene ligaments and the maximum porosity level of the resulting porous particles. A Tₘₐₓ in the range of 500-1,500° C. tends to result in thinner ligaments (1-3 graphene planes); Tₘₐₓ of 1,500-2,500° C. leads to 3-7 graphene planes; and Tₘₐₓ of 2,500-3,000° C. leads to 7-20 graphene planes. A higher Tₘₐₓ for a longer period of heat treatment time leads to a higher degree of graphitization of MCMBs and progressively smaller amount of amorphous zones left in the MCMB.
2) Given the same MCMBs, a higher activation temperature and longer activation time lead to a higher porosity level, but the number of graphene planes in graphene ligaments appears to be relatively independent of the activation time and temperature.
3) An excessively long activation time (e.g. >3 hours) would consume too much carbon material, reducing the production yield of the 3D graphene skeleton particles.

The process of depositing Si in the pores was similar to those discussed in Example 2. Subsequently, chemical lithiation of the Si coating was conducted by using 1 M lithium-biphenyl (Li-Bp)/tetrahydrofuran (THF) solution as the prelithiation reagent. Biphenyl (Bp) was chosen because of its unique chemical/electrochemical behavior in different solvents. In ether solvents (e.g., dimethoxyethane (DME) and THF), it can react with lithium metal and form a strong reducing reagent of Li-Bp. Moreover, the resulting Li-Bp solution is relatively stable toward air and moisture, which is critical to the prelithiation in ambient air. Prelithiation was conducted by simply immersing the Si-containing porous MCMB particles in the prelithiation reagent at room temperature for 10-100 minutes. The prelithiated Si-containing carbon particles were subsequently immersed in a liquid polymer solution including of PVDF-HFP dissolved in NMP and then retreated from the liquid solution and dried in a vacuum oven at 60° C. overnight to obtain surface-protected prelithiated anode particulates.

The electrodes were made of these porous, prelithiated particles, mixed with 5 wt % Super-P® and 7 wt % polytetrafluoroethylene (PTFE) binder. The procedure of slurry coating on Cu foil was conducted to produce electrodes having a thickness from 50 μm to 400 μm.

### EXAMPLE 5: Synthesis of Porous Carbon/Tin Composite Nanoparticles and Si Deposition

The synthesis of the porous C/Sn composite materials included three steps: preparation of polymer solution, SnO₂ nanoparticle dispersion, and carbonization. All materials were purchased from Sigma-Aldrich and were used without further purification. In one example, the polymer solution was prepared by dissolving 0.33 g resorcinol (R), 0.22 g triblock copolymer (Pluronic F127) and 1 ml 1% NaOH aqueous solution in 5 ml N,N-dimethylformamide (DMF), where the triblock copolymer and the NaOH functioned as the soft-template and catalyst, respectively. When the solution was clear, 0.4 g 37% formaldehyde (F) aqueous solution was added. After 30 min vigorous stirring, the solution was stirred for another 30 min at 80° C. to promote the polymerization reaction between resorcinol and formaldehyde. In the meantime, 0.5 g SnO2 nanoparticles (<100 nm) were dispersed into 30 ml DMF by ultrasonication. Then the obtained solution was added into the dispersion and underwent ultrasonic treatment. The mixture was dried while stirring at 100° C. overnight and was further cured in an oven at 100° C. for 24 h. Finally, the polymer/SnO₂ composite was carbonized with a heating rate of 2° C./min in flowing argon at 400° C. for 3 h and then at 700° C. for an additional 3 h. SnO₂ was reduced in the presence of carbon during the carbonization process. For comparison, porous carbon without Sn was synthesized using the same procedure described above. The process for depositing Si in the pores of Sn/C particles or C particles was similar to that described in Example 1.

1. A process for producing a solid powder mass of multiple individual Si-containing porous particulates, said process comprising (a) providing a solid powder mass comprising multiple porous host particles having a volume fraction of pores from 5% to 99.9%, wherein the porous host particles are electrically conducting having an electrical conductivity of no less than 10⁻⁶ S/cm; (b) introducing a reactive liquid or solution, containing a Si precursor, into pores of said porous particles, and (c) exposing said reactive liquid or solution species to heat, ultra-violet light, laser beam, high-energy radiation, or a combination thereof to chemically convert said Si precursor into Si particles residing in said pores or Si coating deposited on pore walls to obtain the solid powder mass of separate multiple Si-containing porous particulates.

2. The process of claim 1, wherein (i) the porous host particles are selected from carbonaceous, graphitic, graphene, or metallic particles; and/or (ii) said reactive liquid or solution comprises silane-type species, as a Si precursor, selected from Cyclohexasilane (CHS), Hexasilane (HS), Cyclopentasilane (CPS), neo-pentasilane (NPS), Tectrasilane, Trisilane, a chemical derivative thereof, a combination thereof, or a combination thereof with disilane or monosilane.

3. The process of claim 1, wherein said Si-containing porous particulates contain a residual pore-to-Si volume ratio from 0.5 to 5.0, preferably from 1.0 to 3.0.

4. The process of claim 1, wherein said Si coating or Si particles have a thickness or diameter from 1 nm to 1 μm, preferably from 10 nm to 500 nm and further preferably from 20 nm to 150 nm.

5. The process of claim 2, wherein said porous graphene particles comprise graphene sheets selected from pristine graphene, graphene fluoride, graphene chloride, graphene bromide, graphene iodide, nitrogenated graphene, hydrogenated graphene, doped graphene, chemically functionalized graphene, graphene oxide, reduced graphene oxide, or a combination thereof.

6. The process of claim 2, wherein said porous carbonaceous or graphitic particles comprise particles of activated carbon, soft carbon, hard carbon, polymeric carbon, activated natural graphite, activated artificial graphite, exfoliated graphite worms, expanded graphite flakes, meso-phase carbon, needle coke, or a combination thereof.

7. The process of claim 2, wherein said host metallic particles comprises a metal selected from a transition metal, Al, Ga, In, Sn, Bi, an alloy thereof, or a combination thereof.

8. The process of claim 1, further comprising a procedure of encapsulating or coating the porous anode material particulates with a thin protecting layer having a thickness from 0.5 nm to 2 μm, wherein the protecting layer comprises carbon, graphene, electron-conducting polymer, lithium ion-conducting polymer, or a combination thereof.

9. The process of claim 1, further comprising a procedure of prelithiating the Si coating or Si particles in the pores of the multiple particulates, wherein said Si coating or particles are prelithiated to contain an amount of lithium from 1% to 100% of a maximum lithium content contained in Si or said prelithiated Si coating or particles contain LiₓSi, wherein numerical x is from 0.01 to 4.4.

10. The process of claim 9, further comprising a procedure of encapsulating or coating the prelithiated multiple anode material particulates with a thin protecting layer having a thickness from 0.5 nm to 2 μm.

11. The process of claim 10, wherein said protecting layer comprises a carbon material, graphene, a polymer, or a lithium- or sodium-containing species chemically bonded to said particulates and said lithium- or sodium-containing species is selected from Li₂CO₃, Li₂C₂O₄, LiOH, LiCl, LiI, LiBr, ROCO₂Li, HCOLi, ROLi, (ROCO₂Li)₂, (CH₂OCO₂Li)₂, Li₂S, LiₓSO_{y}, Li₄B, Na₄B, Na₂CO₃, Na₂O, Na₂C₂O₄, NaOH, NaX, ROCO₂Na, HCONa, RONa, (ROCO₂Na)₂, (CH₂OCO₂Na)₂, Na₂S, NaₓSO_{y}, a combination thereof, a combination thereof with Li₂O or LiF, or a combination of Li₂O and LiF, wherein X=F, Cl, I, or Br, R=a hydrocarbon group, x=0-1, y=1-4.

12. The process of claim 10, wherein said protecting layer comprises a thin layer of a high-elasticity polymer having a fully recoverable tensile strain from 5% to 1,000%, and a lithium ion conductivity from 10⁻⁷ S/cm to 5×10⁻² S/cm at room temperature.

13. The process of claim 9, wherein said step of prelithiating includes a procedure selected from chemical prelithiation, electrochemical lithiation, solution lithiation, physical lithiation, or a combination thereof.

14. The process of claim 9, wherein said step of prelithiating includes conducting electrochemical prelithiation in the first electrodeposition chamber or in a second electrodeposition chamber different than the first chamber.

15. The process of claim 1, further comprising a step of forming said multiple Si-containing porous particulates, along with a binder and conductive additive, into an anode electrode.

16. The process of claim 15, further comprising a step of combining said anode electrode with a cathode, and an electrolyte to form a battery cell.

17. The process of claim 1, further comprising a step of forming said multiple Si-containing porous particulates, into an anode electrode.

18. A solid powder mass of multiple Si-containing porous particulates produced by the process of claim 1.

19. An anode or negative electrode comprising multiple Si-containing porous particulates produced by the process of claim 1, a conductive additive and a binder.

20. A lithium-ion or lithium metal battery containing the anode of claim 19, a cathode, and an electrolyte in ionic contact with the anode and the cathode.

21. An anode or negative electrode comprising multiple Si-containing porous particulates produced by the process of claim 1.
